(19) United States
(12) Patent Application Publication
(10) Pub. No.: US 2006/0192658 A1
(43) Pub. Date: Aug. 31, 2006

(54) Drive recorder and control method therefor

(75) Inventor: Kazuya Yamamura, Gunma (JP)

Correspondence Address: FISH & RICHARDSON P.C., P.O. BOX 1022, MINNEAPOLIS, MN, 55440-1022, US

(73) Assignee: Sanyo Electric Co., Ltd., Moriguchi-shi (JP)

(21) Appl. No.: 11/333,784

(22) Filed: Jan. 18, 2006

(30) Foreign Application Priority Data
Jan. 21, 2005 (JP) 2005-014615

(51) Int. Cl. B60Q 1/00; H04N 7/18; B60R 25/10; G08B 19/00

(52) U.S. Cl. 340/425.5; 348/148; 340/426.1; 340/521

(57) ABSTRACT

A drive recorder 1 comprises a volatile memory 15, a nonvolatile memory 16, an image collection unit 111 that stores in real-time image data into the volatile memory 15, an acceleration collection unit 112, a sound collection unit 113 that stores in real-time sound data into the volatile memory 15, an acceleration comparison unit 114 that determines in real-time whether the acceleration exceeds a threshold value, a sound recognition unit 115 that determines if the sound data includes an accident sound which is a distinctive sound that is generated at an accident, by performing sound recognition on sound data when the acceleration exceeds the threshold value, and a data transcribe unit 116 that transcribes image data stored in the volatile memory 15 into the nonvolatile memory 16 when it is determined that the accident sound is included in the sound data.

### CROSS-REFERENCE TO RELATED APPLICATIONS

The present application claims priority from Japanese Patent Application No. 2005-14615 filed on Jan. 21, 2005, which is herein incorporated by reference.

### BACKGROUND OF THE INVENTION

1. Field of the Invention

The present invention relates to a drive recorder and control method therefor, and relates particularly to technology for realizing a drive recorder having high recognition accuracy On the occurrence/nonoccurrence of an accident.

2. Description of the Related Art

Japanese Patent Application Laid-open Publication No. 2000-6854 discloses a drive recorder that can record the circumstances of a vehicle accident. That drive recorder has a function to store in real-time into the RAM (Random Access Memory) images taken by a CCD camera and information (hereinafter called ‘accident information’) collected by various sensors, and transcribes the above information into a nonvolatile memory such as a flash memory at the moment the acceleration collection unit detects a collision. The reason why as such, accident information is stored into the RAM is because the operation of a RAM is generally at much higher speed than that of a nonvolatile memory, whereas the purpose for transcribing accident information into the flash memory at the moment a collision is detected is to enable reliably saving the accident information even if the power supply to the drive recorder is cut.

Meanwhile, a conventional drive recorder with functions as above, has a configuration so that accident information is transcribed into the flash memory in the case an impact equal to or greater than a predetermined threshold value (e.g., 0.4 G) is detected by the acceleration collection unit (acceleration sensor). Therefore, in a case the above threshold value is set permissively, improper operations frequently occur due to reasons besides accidents such as sudden braking or abrupt steering and sudden acceleration. This generates unnecessary processes of transcribing data thus causing problems of wasting electricity as well as shortening the flash memory life. On the other hand, in a case the threshold value is set too strictly, the drive recorder may not operate at an accident, which is the most important thing. As such, it was very difficult to set the above threshold value appropriately.

Meanwhile, in order to improve the admissibility of evidence of accident information as well as to handle the problems of fraud such as falsifying or deleting accident information, future drive recorder products are to be designed to prevent the flash memory from being overwritten after-the-fact, in other words, designed such that data can be written at once. To implement write-at-once as above, a mechanism to reliably capture the actual moment of an adcident with the possibilities of malfunction minimized needs to be realized.

### SUMMARY OF THE INVENTION

The present invention was made in view of such background, and an object thereof is to provide a drive recorder and a control method therefor, wherein the drive recorder has high accuracy in recognition of the occurrence/nonoccurrence of an accident.

According to the main aspect of the present invention to achieve the above and other objectives, there is provided a drive recorder which comprise a first memory; a second memory; an image collection unit that stores in real-time into the first memory image data representing images captured while a vehicle is in motion; an acceleration collection unit that collects acceleration while the vehicle is in motion; a sound collection unit that stores in real-time sound data representing sound while the vehicle is in motion; an acceleration comparison unit that determines in real-time whether the acceleration collected by the acceleration collection unit exceeds a threshold value; a sound recognition unit that determines if the sound data includes an accident sound which is a distinctive sound that is generated at an accident by performing sound recognition on the sound data when the acceleration exceeds the threshold value; and a data transcribe unit that transcribes image data stored in the first memory into the second memory when the sound recognition unit determines that the accident sound is included in the sound data.

If the acceleration exceeds the threshold value, the drive recorder of the present invention performs sound recognition of sample sound data and transcribes image data into the nonvolatile memory only when the accident sound is determined to be included in the sound data. As such, in addition to determination on the basis of the acceleration, determination using sound recognition enables high accuracy determination of the occurrence/nonoccurrence of an accident and thus minimizes wasted electricity as well as extends the life of a nonvolatile memory compared to that of a conventional drive recorder. Further, writing data into a nonvolatile memory enables a write at once method drive recorder to be commercialized. Furthermore, high speed sound recognition with the use of a DSP or the like enables reliably storing image data into a nonvolatile memory, captured accurately at the occurrence time of an accident.

According to the present invention, a drive recorder and control method therefor with high accuracy in recognizing the occurrence/nonoccurrence of an accident is provided.

Features and objects of the present invention other than the above will become apparent from the description of this specification and the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 illustrates characteristic functions realized by a drive recorder 1 according to an implementation of the present invention;

FIG. 2 illustrates the hardware configuration of the drive recorder 1 according to the implementation of the present invention;

FIG. 3 is a flow chart illustrating the basic operation of the drive recorder 1 according to the implementation of the present invention; and

FIG. 4 is a flow chart illustrating another implementation of the operation of the drive recorder 1 according to the implementation of the present invention.

### DETAILED DESCRIPTION OF THE INVENTION

At least the following matters will be made clear by the explanation in the present specification and the description of the accompanying drawings.

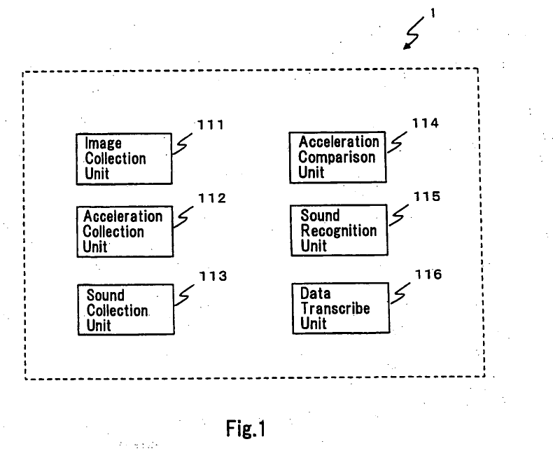

An implementation of the present invention will be described in detail below. FIG. 1 illustrates characteristic functions of a drive recorder 1 according to the implementation of the present invention. An image collection unit 111 of FIG. 1 stores in real-time into a first memory, image data representing images captured while the vehicle is in motion. An acceleration collection unit 112 measures the acceleration of the vehicle in motion. A sound collection unit 113 stores in real-time into the first memory, sound data representing sound captured while the vehicle is in motion. An acceleration comparison unit 114 compares in real-time acceleration with the threshold value and determines whether or not the acceleration exceeds the threshold value. When it is determined that the acceleration has exceeded the threshold value, a sound recognition unit 115 determines if a distinctive sound that occurs at an accident (hereinafter called ‘accident sound’) is included in the sound data by performing sound recognition on the sound data collected by the sound collection unit 113. In the case the above sound data is determined to include accident sound, a memory transcribe unit 116 transcribes image data stored in the first memory into a second memory.

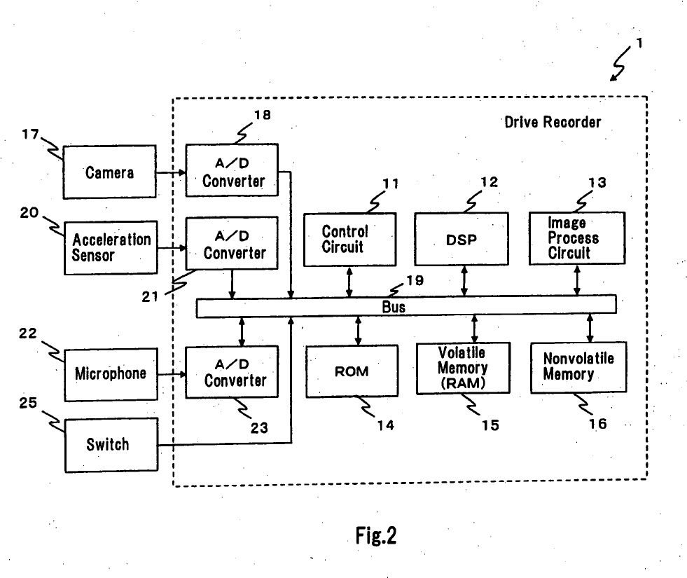

FIG. 2 illustrates the hardware configuration of the drive recorder 1 according to the implementation of the invention to be explained. A control circuit 11 in FIG. 2 is configured to include such as a CPU (Central Processing Unit) and a PLD (Programmable Logic Device). A DSP (Digital Signal Processor) 12 is a digital signal processing circuit to speed up various processes for image signal and audio signal. An image process circuit 13 generates image data by performing process on image signals such as data compression.

A ROM (Read Only Memory) 14 is such as a PROM (Programmable Read Only Memory), an EPROM (Erasable and Programmable Read Only Memory) or an EEPROM (Electronically Erasable and Programmable Read Only Memory). Programs to be executed by the control circuit 11 and various data are stored in the ROM 14.

A volatile memory 15 functions as the first memory. The volatile memory 15 is a RAM (Random Access Memory) such as a SRAM (Static Random Access Memory) or a DRAM (Dynamic Random Access Memory). Further, a nonvolatile memory 16 functions as the second memory. The nonvolatile memory 16 is memory such as Flash Memory, FeRAM (Ferroelectric RAM) and MRAM (Magnetic RAM) that can store data even after the power supply is cut.

A camera 17 is configured with an image pickup device such as a CCD (Charge Coupled Device) image sensor or a CMOS (Complementary Metal-Oxide Semiconductor) image sensor and outputs an analog image: signal. This image signal is digitalized by an A/D converter 18 and supplied to a bus 19. Additionally, the A/D converter 18 can be built into the camera 17. Further, the camera 17 can be housed inside the housing of the drive recorder 1 or be external to the housing. Furthermore, a plurality of cameras 17 can be connected to the drive recorder 1 so as to be directed in plural directions for images. The camera 17 is usually fixed at an appropriate location to photograph the circumstances of an accident, such as close to the windshield or the rearview mirror. The image collection unit 111 includes, for example, a camera 17 and an A/D converter 21. Moreover, the camera 17 need not necessarily be included in the image collection unit 111.

An acceleration sensor 20 outputs an analog voltage corresponding to the acceleration applied thereto. This analog voltage is digitalized by the A/D converter 21 and supplied to the bus 19. The acceleration sensor 20 can be housed inside the housing of the drive recorder 1 or be external to the housing separately. A plurality of acceleration sensors 20 can be provided to detect acceleration in plural directions. The acceleration sensor 20 is usually fixed at an appropriate position to detect acceleration being applied to the vehicle, such as in the bonnet or the dashboard of the vehicle. The acceleration collection unit 112 includes, for example, an acceleration sensor 20 and an A/D converter 21. Moreover, the acceleration sensor 20 need not necessarily be included in the acceleration collection unit 112.

A microphone 22 outputs an analog audio signal corresponding to the collected sound. The audio signal outputted from the microphone 22 is digitalized by the A/D converter 23 and supplied to the bus 19. The microphone 22 can be housed inside the housing of the drive recorder 1 or be external to the housing. The microphone 22 is usually fixed to an appropriate position to collect sound being generated when an impact is detected, such as in the bonnet or the dashboard of the vehicle. Additionally, the sound collection unit 113 includes, for example, a microphone 22 and an A/D converter 23. The microphone 22 need not necessarily be included in the sound collection unit 113.

A switch 25 connected to the bus 19 via an interface (not shown) such as an I/O port is an user interface to be operated when image data stored in the volatile memory 15 is forcibly transcribed into the nonvolatile memory 16 by the user. When the control circuit 11 detects that the switch 25 is turned on, it transcribes the image data stored in the volatile memory 15 into the nonvolatile memory 16. For instance, in the case the image data has not been transcribed into the volatile memory 15 for some reason, the user operates the switch 25 to forcibly transcribe the image data into the nonvolatile memory 16. Additionally, the drive recorder 1 of the present implementation is of a write-at-once method later described, and therefore where writing data into the nonvolatile memory 16 is being performed normally (i.e. when a later-described write inhibit flag is on), even if the switch 25 is turned on by the user, the control circuit 11 does not forcibly transcribe the image data to the nonvolatile memory 16.

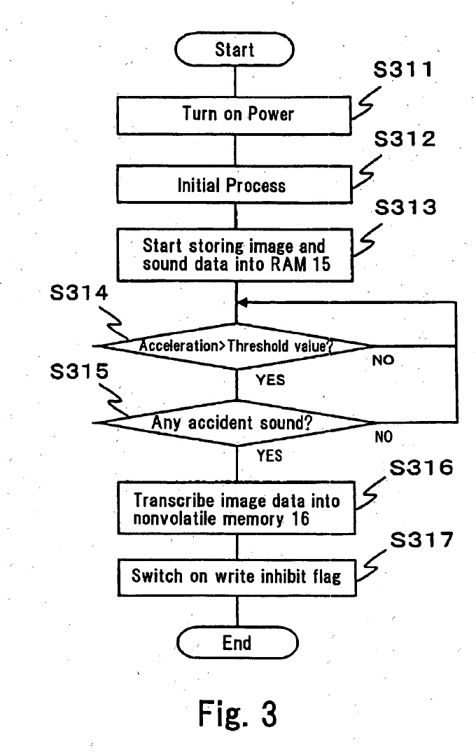

Next, explanation is presented of the process performed by the drive recorder 11. FIG. 3 is a flowchart illustrating the basic processes by the drive recorder 1 of the present implementation. First, the power supply to the driver recorder 1, for example, starts in conjunction with the initiation of power supply to the electrical system of the vehicle by the user operating the ignition switch or the like provided in the vehicle (S311). When the power supply is initiated to the drive recorder 1, then the control circuit 11 performs an initial process (S312), followed by starting to store in real-time into the nonvolatile memory 15, image data outputted from the image processing circuit 13 captured by camera 17 and sound data of audio signals outputted from the. A/D converter 23 that have originated in the microphone 22 (S313).

Additionally, the storing of image data and sound data in real-time into the memory 15 is performed by circulative overwriting on old data in an image storage area and a sound storage area that are dedicated in the volatile memory 15. Herewith, when a predetermined time elapses after the real-time storing starts, the latest image and sound data for a given period of time are constantly stored in the image and sound storage areas, respectively. The data format of the image data stored in the volatile memory 15 is for example a motion JPEG (Joint Photographic. Experts Group) or a JPEG 2000 (Joint Photographic Experts Group 2000). Further, the data format of the sound data is for example an MP3 (Moving Picture Experts Group 3).

After the power is introduced, the control circuit 11 starts real-time comparison of the acceleration collected by the acceleration sensor 20 with the threshold value set in advance and stored in the ROM 14 (S314). Additionally, used as the aforementioned threshold is, for example, a value obtained from collision experiment results. As described above, while the vehicle is in motion, the process of real-time storing of image and sound data into the volatile memory 15 and the comparison process of S314 continue.

When the vehicle is in motion and when the acceleration exceeds the threshold value (S314: YES) at the comparison process of S314, the control circuit 11 determines if an accident sound is included in the sound data stored in the volatile memory 15 by sound recognition (S315). Additionally, the sound recognition can be performed according to a DTW (Dynamic Time Warping) method (also called a DP matching method), a HMM (Hidden Markov Model) method, a NN (Neural Network) method, or the like. The present implementation adopts the DTW method for sound recognition. Here, as commonly known, in sound recognition using the DTW method, an acoustic model is created from a chronological pattern of characteristic parameters, and under the optimality principle of DP (Dynamic Programming), the chronological pattern of characteristic parameters of the input sound is directly compared in a nonlinear manner with the chronological pattern of the characteristic parameters of the standard model. The drive recorder 1 of the present implementation determines if the accident sound is included in the sound data stored in the volatile memory 15 by calculating the distance (pattern distance), likelihood (probability), similarity, and the like between the chronological patterns of the characteristic parameters of the sound data and of the standard model and comparing at least one of these with a reference value set in advance.

In the above determination, the control circuit 11 reads out sound data of a given period of time from the volatile memory 15 as a sample and then performs sound recognition on this sound data (hereinafter called ‘sample sound data’). The aforementioned given period is for example a continuous time period that includes at least either the time period from a time point before the point when the acceleration exceeds the threshold value (hereinafter called ‘impact detection time’) until the impact detection time, or from the impact detection time until a time point after the impact detection time. To be specific, for example, the control circuit 11 samples sound data of a time period from 10 seconds before to 5 seconds after the impact detection time as the sample sound data. Additionally, as such, the drive recorder 1 of the present implementation performs sound recognition on also the sound data of from a time point before impact detection time until impact detection time, and determines the occurrence/nonoccurrence of an accident also on the basis of a sound predicting an accident such as sound made by a blowing horn and a screeching brake. Therefore, the drive recorder 1 of the present implementation can recognize the occurrence/nonoccurrence of an accident with high accuracy.

The ROM 14 stores the chronological pattern of the characteristic parameters of the standard model which is required in sound recognition by the DTW method. For example this chronological pattern is created from sound collected from, for example, crash experiments simulating actual accidents.

At the process of S315, when it is determined that accident sound is included in the sample data (S315: YES), next, the control circuit 11 transcribes image data of a given time period stored in the volatile memory 15 into the nonvolatile memory 16 (S316). Here the given time period is for example a time period of from 10 seconds before to 5 seconds after the impact detection time.

Upon completion of transcribing the image data into the nonvolatile memory 16, next the control circuit 11 switches on the write inhibit flag provided in a predetermined storage area of the nonvolatile memory 16 (S317). Here, when the write inhibit flag is on, the control circuit 11 prevents image data from being transcribed from the volatile memory 15 into the nonvolatile memory 16. That is to say, image data is transcribed into the nonvolatile memory 16 according to a write-at-once method. As described, the transcribing of image data into the nonvolatile memory 16 according to the write at once method prevents the image data from being rewritten on purpose by applying impact or inputting impact noise or the like into the drive recorder 1. In this way, the admissibility of evidence of accident information is improved and fraud such as falsification or erasing accident information can be prevented. Additionally, concerning the image data to be transcribed into the nonvolatile memory 16, by having each drive recorder 1 embed its distinctive digital watermark therein by the control circuit 11 or the image processing circuit 13, the admissibility of evidence of image data can be further improved. In addition, when the image data is transcribed into the nonvolatile memory 16 at process S316, the sound data of a given time period before and after the accident (e.g. sample sound data) may be transcribed into the nonvolatile memory 16 together with the image data. As such, by transcribing the sound data into the nonvolatile memory 16 as well, the drive recorder 1 is enabled to provide more information on the accident.

In process S315, when it is determined that accident sound is not included in the sample sound data (S315: NO), the control circuit 11 returns to process S314. Then the control circuit 11 continues the process of monitoring acceleration in real-time to identify if the acceleration exceeds the threshold value or not.

As described above, when the acceleration exceeds the threshold value, the drive recorder 1 of the present implementation performs sound recognition on sample sound data and transcribes image data into the nonvolatile memory 16 only when the sound data is determined to include an accident sound. As such, by adopting the process of determining via sound recognition with the acceleration determination as a trigger, the drive recorder 1 of the present implementation can determine the occurrence/nonoccurrence of an accident with higher accuracy than with a conventional drive recorder. Additionally, unnecessary electricity consumption is minimized and the life of the nonvolatile memory 16 is extended compared to that of a conventional drive recorder. Further, the drive recorder 1 which writes data into the nonvolatile memory 16 according to the write at once method can be commercialized. Furthermore, since the DSP 12 performs high speed sound recognition, the occurrence timing of an accident is accurately captured and the image data is reliably stored into the nonvolatile memory 16.

Next, another implementation of the operation of the drive recorder 1 will be explained. In the implementation described above, sound recognition is performed on the sound data of a continuous time period. However, in the implementation described hereunder, sound recognition is performed separately on sound data of a continuous time period from a time point before the impact detection time until the impact detection time (hereinafter called ‘first sample sound data’) and sound data of a continuous time period from the impact detection time to a point after the impact detection time (hereinafter called ‘second sample sound data’). Additionally, for example, the first sample sound data is sound data of a time period of 10 seconds before the impact detection time until the impact detection time and the second sample sound data is sound data of a time period from the impact detection time until 5 seconds after the impact detection time.

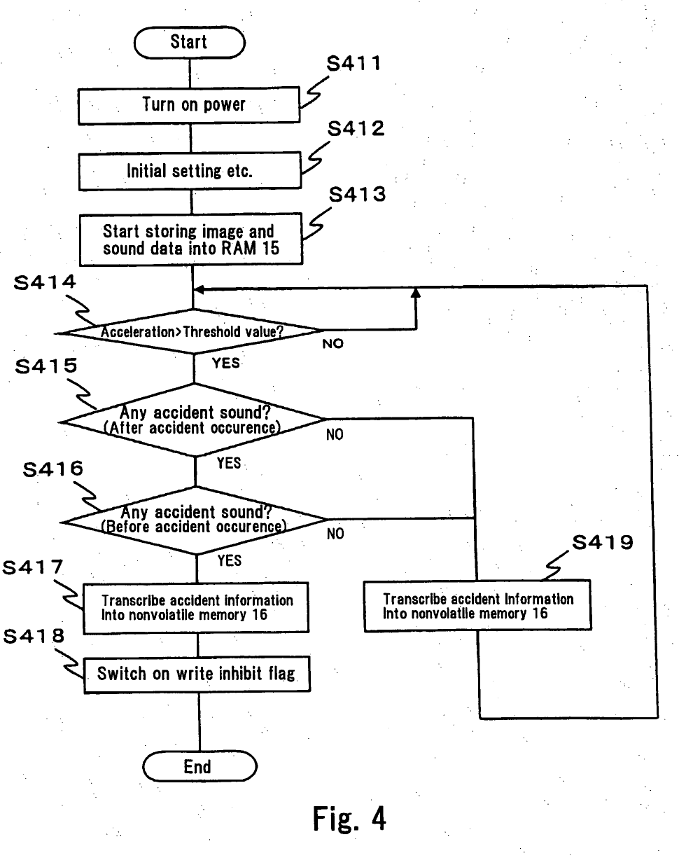

FIG. 4 illustrates a flowchart which describes the other implementation of the operation of the drive recorder 1. Processes at S411 to S414 in FIG. 4 are the same as the processes at S311 to S314 in FIG. 3. In process S415, the control circuit 11 performs sound recognition on the second sample sound data of the sound data stored in the volatile memory 15 to determine if an accident has occurred or not (S415). When it is determined at process S415 that an accident sound is included in the second sample sound data (S415: YES), the process proceeds to S416.

When it is determined at process S415 that an accident sound is not included in the second sound data sample (5415: NO), the control circuit 11 transmits image data of a given time period stored in the volatile memory 15 into the nonvolatile memory 16 (S419). Thereafter, the process returns to S414 and the control circuit 11 restarts the process of monitoring acceleration in real-time to identify if the acceleration exceeds the threshold value or not. In addition, in this implementation even if the drive recorder determines that an accident sound is not included in the second sample sound data as described, the image data is stored into the nonvolatile memory 16, though it can be overwritten into (not being in a write-at-once state).

Next, in process S416, the control circuit 11 reads out the first sample sound data and by performing sound recognition on this sound data, the occurrence/nonoccurrence of an accident is determined (S416). Here, when it is determined that the first sample sound data includes an accident sound (S416: YES), the process proceeds to S417. On the other hand, when it is determined that the first sample sound data does not include an accident sound (S416: NO), the control circuit 11 transcribes image data of a given time period stored in the RAM into the nonvolatile memory 16 (S419). Then, the process returns to S414 and restarts to monitor the acceleration at real-time to identify if the acceleration exceeds the threshold value or not.

As described, in the present implementation, even when it is determined that an accident sound is not included in the first sound data sample, image data is transcribed into the nonvolatile memory 16. That is, in the present implementation, where the sound recognition test is not passed for some reason either before or after impact detection time despite the occurrence of an accident, image data is stored into the nonvolatile memory 16, though it can be overwritten into (not being in a write-at-once state), improving the utility value (usefulness) of the drive recorder 1. Additionally, when the image data is transcribed into the nonvolatile memory 16 at process S419, sound data of a given time period before or after an accident (e.g. the first sample sound data or the second sample sound data) may be transcribed into the nonvolatile memory 16 together with image data. As such, by transcribing sound data as well into the nonvolatile memory 16, the drive recorder 1 is enabled to provide more information on an accident.

At process S417, the control circuit 11 transcribes image data of a given time period stored in the volatile memory 15 into the nonvolatile memory 16 (S417). Next, as at the process 317 in FIG. 3, when completing transcribing image data into the nonvolatile memory 16, the control circuit 11 switches on the write inhibit flag (S418).

As described above, in the present implementation, sound recognition of the first sample sound data and the second sample sound data having different characteristics are performed separately. Therefore, sound recognition can be performed with higher accuracy compared with where sound recognition is performed on sound data before and after the impact detection time without distinguishing the two, and thus enabling determining with high accuracy the occurrence/nonoccurrence of an accident.

Further, in the present implementation, even when at least either the first sample sound data or the second sample sound data does not pass the sound recognition test, the image data is saved in the drive recorder 1. Therefore, even in the case the drive recorder 1 fails to operate normally for some reason though an accident has occurred, image data is stored into the nonvolatile memory 16, thereby improving the utility value (usefulness) of the drive recorder 1. Additionally, although sound recognition of the second sample sound data is performed first in the implementation, sound recognition of the first sample sound data can be performed first.

The above implementation is provided to facilitate the understanding of the present invention and not intended to limit the present invention. It should be understood that various changes and alterations can be made therein without departing from spirit and scope of the invention and that the present invention includes its equivalents.

For example, a nonvolatile memory such as a Flash Memory can be used instead of the volatile memory 15. Further for example, in the case devices such as a vehicle speed sensor, a throttle position sensor, a brake sensor, an in-car radar, a seatbelt sensor, and a GPS are mounted in the vehicle, information relating to accidents such as vehicle speed, throttle position, brake operation conditions, positional relation with the object subject to collision, usage of the seatbelt, information on vehicle location may be transcribed into the nonvolatile memory 16 together with image data or instead of image data.

What is claimed is:

1. A drive recorder comprising:
a first memory;
a second memory;
an image collection unit that stores in real-time into said first memory image data representing images captured while a vehicle is in motion;
an acceleration collection unit that collects acceleration while the vehicle is in motion;
a sound collection unit that stores in real-time sound data representing sound while the vehicle is in motion;
an acceleration comparison unit that determines in real-time whether; the acceleration collected by said acceleration collection unit exceeds a threshold value;
a sound recognition unit that determines if said sound data includes an accident sound which is a distinctive sound that is generated at an accident by performing sound recognition on said sound data when the acceleration exceeds said threshold value; and
a data transcribe unit that transcribes image data stored in said first memory into said second memory when said sound recognition unit determines that said accident sound is included in said sound data.

2. The drive recorder as recited in claim 1, wherein of the sound data stored by said sound collection unit, said sound recognition by said sound recognition unit is performed on sound data of a continuous time period that includes at least either a time period from a time point before impact detection time when the acceleration exceeds the threshold value until the impact detection time or a time period from the impact detection time until a time point after the impact detection time.

3. The drive recorder as recited in claim 2, wherein transcribing said image data into said second memory is performed according to a write at once method.

4. The drive recorder as recited in claim 1, wherein of the sound data stored by said sound collection unit, said sound recognition is performed separately on a first sample sound data that is sound data of a continuous time period from a time point before impact detection time when the acceleration exceeds the threshold value until the impact detection time and on a second sample sound data that is sound data of a continuous time period from the impact detection time until a time point after the impact detection time.

5. The drive recorder as recited in claim 4, wherein if it is determined that a distinctive accident sound that is generated at an accident is included in at least either said sound recognition of said first sample sound data or that of said second sample sound data, said data transcribe unit transcribes said image data stored in said first memory into said second memory.

6. The drive recorder as recited in claim 4, wherein if it is determined that a distinctive accident sound that is generated at an accident is included in both said sound recognition of said first sample sound data and that of said second sample sound data, said data transcribe unit transcribes said image data stored in said first memory into said second memory according to a write at once method.

7. The drive recorder as recited in claim 1, wherein said sound recognition by said sound recognition unit is according to a DTW (Dynamic Time Warping) method.

8. The drive recorder as recited in claim 7, wherein of the sound data stored by said sound collection unit, said sound recognition is performed separately on a first sample sound data that is sound data of a continuous time period from a time point before impact detection time when the acceleration exceeds the threshold value until the impact detection time and on a second sample sound data that is sound data of a continuous time period from the impact detection time until a time point after the impact detection time, by comparing with chronological patterns respectively prepared for said first sample sound data and said second sample sound data is performed.

9. The drive recorder as recited in claim 1, wherein said sound recognition by said sound recognition unit is according to an HMM (Hidden Markov Model) method or an NN (Neural Network) method.

10. The drive recorder as recited in claim 1, wherein said data transcribe unit embeds digital watermark in said image data to be transcribed into said second memory.

11. The drive recorder as recited in claim 1, wherein said data transcribe unit transcribes said sound data stored by said sound collection unit into said second memory if said sound recognition unit determines that said accident sound is included in said sound data.

12. The drive recorder as recited in claim 1, wherein said data transcribe unit transcribes into said second memory together with or instead of said image data, information collected from a vehicle speed sensor, a throttle position sensor, a brake sensor, an in-car radar, a seatbelt sensor or a GPS.

13. The drive recorder as recited in claim 1, wherein said first memory is a volatile memory and said second memory is a nonvolatile memory.

14. The drive recorder as recited in claim 1, further comprising an user interface,
wherein said data transcribe unit forcibly transcribes image data stored in said first memory into said second memory if it is detected that a predetermined operation has been performed on said user interface.

15. A drive recorder comprising:
a control circuit;
a volatile memory;
a nonvolatile memory;
a camera;
an acceleration sensor;
a microphone;
an image collection unit that stores in real-time image data representing images captured while a vehicle is in motion;
an acceleration collection unit that collects acceleration while the vehicle is in motion;
a sound collection unit that stores in real-time sound data representing sound while the vehicle is in motion;
an acceleration comparison unit that determines in real-time whether the acceleration collected by said acceleration collection unit exceeds a threshold value;
a sound recognition unit that determines if said sound data includes an accident sound which is a distinctive sound that is generated at an accident by performing sound recognition on said sound data when the acceleration exceeds said threshold value; and
a data transcribe unit that transcribes image data stored in said volatile memory into said nonvolatile memory when said sound recognition unit determines that said accident sound is included in said sound data.

16. A control method for a drive recorder having a first memory, a second memory, an image collection unit that stores in real-time into said first memory image data representing images captured while a vehicle is in motion, an acceleration collection unit that, collects acceleration while the vehicle is in motion, a sound collection unit that stores in real-time sound data representing sound while the vehicle is in motion, comprising the steps of:
determining in real-time whether the acceleration collected by said acceleration collection unit exceeds a threshold value;
determining if said sound data includes an accident sound which is a distinctive sound that is generated at an accident by performing sound recognition on said sound data collected by said sound collection unit when the acceleration exceeds the threshold value; and
transcribing said image data stored in said first memory into said second memory when said accident sound is
determined to be included in said sound data.
